(19) United States
(12) Patent Application Publication
(10) Pub. No.: US 2019/0386895 A1
(43) Pub. Date: Dec. 19, 2019

(54) EAST-WEST TRAFFIC MONITORING SOLUTIONS FOR THE MICROSERVICE VIRTUALIZED DATA CENTER LAN

(71) Applicant: AT&T Intellectual Property I, L.P., Atlanta, GA (US)

(72) Inventors: Timothy INNES, Atlanta, GA (US); Behzad SHAHRARAY, Holmdel, NJ (US); Eric ZAVESKY, Austin, TX (US); James PRATT, Round Rock, TX (US); Nigel BRADLEY, McDonough, GA (US)

(73) Assignee: AT&T Intellectual Property I, L.P.

(21) Appl. No.: 16/007,483

(22) Filed: Jun. 13, 2018

(51) Int. Cl. H04L 12/26; G06F 9/455

(52) U.S. Cl. CPC H04L 43/04; G06F 2009/45595; G06F 9/45558

(57) ABSTRACT

Systems and methods for east-west traffic monitoring involve generating an east-west record based on a traffic interaction at a virtualized node and storing the east-west record using a record cache of a peripheral memory device associated with the virtualized node. The east-west record includes a source, a destination, a type, and a hypervisor identifier.

### TECHNICAL FIELD

This disclosure relates generally to network management and, more specifically, to monitoring a variety of traffic types in network environments leveraging virtualization.

### BACKGROUND

Data centers are increasingly driven by a service oriented architecture leveraging microservices, or applications which are implemented in cloud environments as loosely coupled services. Monolithic applications (conventional single-tier programs) are also being decomposed into smaller services or microservices. Calls to these services often result in virtual machine (VM) to virtual machine traffic.

The majority of traffic in networks travels between servers and clients. This is referred to as “north-south” traffic. However, an increasing amount of traffic is “east-west” traffic, which includes (but is not limited to) server-to-server (or VM-to-VM as described above) as a result of cloud-implemented services.

### SUMMARY

In an aspect, a method comprises generating an east-west record based on an east-west traffic interaction at a node. The east-west record includes a source, a destination, and a type. The method can further include storing the east-west record in a record cache of a peripheral memory device associated with the node.

In another aspect, a system comprises a record generator configured to generate an east-west record based on a traffic interaction at a node. The east-west record includes a source, a destination, and a type. The system also comprises a record cache of a peripheral memory device associated with the node configured to store the east-west record.

According to yet another aspect, a non-transitory computer readable medium stores instructions. When executed, the instructions perform aspects including generating an east-west record based on a traffic interaction at a virtualized node and storing the east-west record using a record cache of a peripheral memory device associated with the virtualized node. The east-west record includes a source, a destination, a type, and a hypervisor identifier.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

In the following description, for purposes of explanation, numerous specific details are set forth in order to provide an understanding of the variations in implementing the disclosed technology. However, the instant disclosure may take many different forms and should not be construed as limited to the examples set forth herein. Where practical, like numbers refer to like elements throughout.

FIG. 1A is a representation of an example network.

FIG. 1B is a representation of an example hardware platform for a network.

FIG. 1C is a representation of an example system for implementing east-west traffic monitoring.

FIG. 2A is a method that may be used to implement east-west traffic monitoring.

FIG. 2B is another method that may be used to implement east-west traffic monitoring.

FIG. 3 is a schematic of an example device that may be a component of the system of FIG. 2A.

FIG. 4 depicts an example communication system that provide wireless telecommunication services over wireless communication networks upon which an application may be deployed using the disclosed systems or methods.

FIG. 5 depicts an example communication system that provide wireless telecommunication services over wireless communication networks that may be modeled using the disclosed systems and methods for configuring a virtualized network platform.

FIG. 6 is a diagram of an example telecommunications system in which the disclosed systems or methods may be implemented.

FIG. 7 is an example system diagram of a radio access network and a core network upon which an application may be deployed using the disclosed systems or methods.

### DETAILED DESCRIPTION

As noted above, east-west traffic presents a substantial amount, and increasing proportion, of traffic in data centers. Conventional techniques do not observe this traffic, and alternative efforts to create new, separate monitoring nodes for east-west traffic monitoring could require significant resource commitment, which in turn result in increased power consumption and heat generation. Understanding and managing east-west traffic is important for security, efficiency, performance, and cost, but must be balanced such that the monitoring solution itself does not increase costs. An east-west traffic monitoring solution should report the health of VMs (faults, failures, incorrect lifecycle transitions) and the efficiency of inter-service communications (latency, usage or idle time, inter-service traffic patterns) while avoiding performance degradation (bottlenecking, memory usage, storage usage) and undue power requirements (or related cooling requirements).

An unconventional solution to this problem involves collecting new records having a new record format, the East-West Record (EWR), which can include, for some or every piece of traffic into or out of a node, data fields for or representations of packet type, source identification, destination identification, and (for virtualized nodes) hypervisors involved. EWR generation can be conducted at a switch-level (using, e.g., hardware or virtual switches), node-level, or at various other levels within a network architecture. To limit the burden on network or node resources, embodiments of the solution can utilize a peripheral memory device (PMD) for each node that stores EWRs until its cache is full, then transmits its cache of EWRs to an EWR database before clearing its cache including the PMD. In some embodiments, an east-west engine processing the EWRs can aggregate behavior, recognize patterns, provide summaries or details regarding traffic, illustrate traffic, propagate automated rule updates to nodes, and perform other computation, manipulation, or provisioning of EWR data.

Scenarios for east-west traffic relate to traffic between nodes which can use the same or different physical machines, port groups, and virtual switches, and may be located in the same or different data centers, all of which have impacts on speed and latency. To capture all of these east-west communications regardless of these paths, each VM creates an EWR upon sending any traffic and upon receipt of any traffic. For external communication (external service to VM) the internal VM will create an EWR on sending or receiving such service regardless of whether such service captures its own EWR.

When aggregated (after EWRs are sent to the EWR database and caches cleared), analytics and processing are performed in a manner decoupled and distinct from conventional firewall deep packet inspection strategies. Analytics can assess east-west traffic at a global level, at a vendor level, at a customer level, at a cost, level, et cetera. Design topologies can be developed to plan for east-west traffic, and other functions (load balancing, application programming interface (API) gateways, application decomposition strategies, network security) can also be developed (in embodiments, automatically) to accommodate east-west traffic.

Adding to the efficiency of this solution, new EWR traffic is offset by reductions to other traffic in a network architecture. For example, in legacy networks, ping and probe traffic can be used to determine the status of various network nodes. The volume and corresponding cost of such traffic increases in virtualized environments, where dynamic architecture instantiates, modifies, and destroys nodes in a manner which node monitoring (e.g., ping and/or probe) becomes more complex. EWR supplants legacy monitoring techniques, obviating the need for query and response traffic and thereby offsetting its own traffic when caches are downloaded to record databases.

As used herein, “east-west traffic” includes communication at varying levels of granularity between servers (physical or virtual), and more generally VMs and processes running thereon or in conjunction therewith, as well as services or components thereof, et cetera, supported by resources in a common datacenter or a portion thereof. In alternative embodiments, such VM-to-VM (or other east-west traffic) can be supported by resources in disparate datacenters, or disparate portions of one or more datacenters, without departing from the scope or spirit of this disclosure. In still further alternative or complementary embodiments, east-west traffic can be generated by network elements, such as switches or vSwitches, HSSs or vHSSs, MMEs or vMMEs, et cetera, residing in common datacenters, or residing in different datacenters, without departing from the scope or spirit of the innovation. In a particular embodiment, east-west traffic comprises traffic between two or more virtual instances supported by resources in the same datacenter.

As used herein, a “record” can be an east-west record or another record memorializing the existence of traffic in a network and/or containing details about traffic within a network. Records herein can include records of east-west or north-south traffic, and may be collected for some or all traffic to, from, or through one or more nodes. While some aspects herein describe records as inclusive of information related to north-south and east-west traffic, it is understood that embodiments disclosed herein may concern only east-west traffic without departing from the scope or spirit of the innovation.

As used herein, a virtualized node is a node instantiated in a virtualized environment. Virtualized nodes can include, but are not limited to, virtual machines, services, micro-services, et cetera. Virtualized nodes, as well as non-virtualized nodes (e.g., hardware servers, hardware firewalls, hardware switches, hardware gateways, individual computers or devices), can engage in traffic interactions, which can include any communication, signal, message, et cetera, to, from, or through a node. Nodes can be sources or destinations when handling traffic, and a source or destination may be an intermediary as a particular communication propagates or moves through a network, or based on interrelated sources or destinations utilized in completing a task (e.g., portions of a micro-services operating as different nodes to perform the function of the service). Records can be collected for traffic involving (e.g., to or from, as a first origin, final destination, or intermediary) virtualized nodes or non-virtualized nodes.

Hypervisors can be used to manage virtual machines, services, or other virtual nodes. A hypervisor identifier as used herein can be a unique identifier, or an indication of a particular specification, for a particular hypervisor in a network.

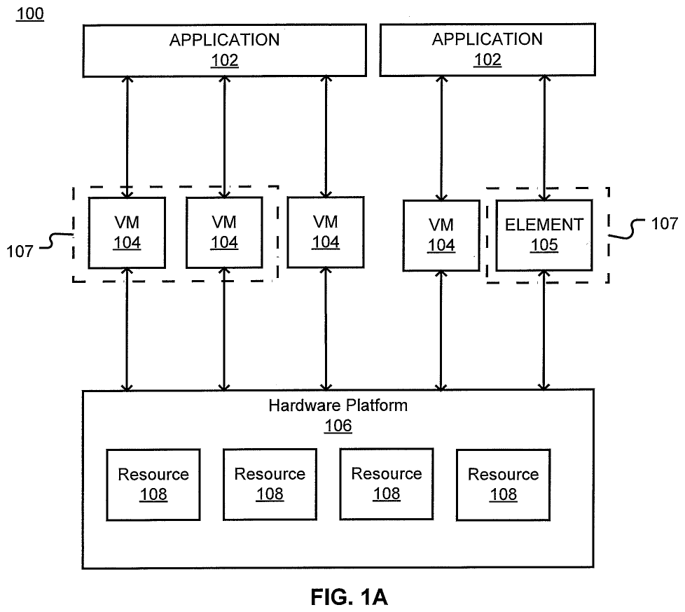

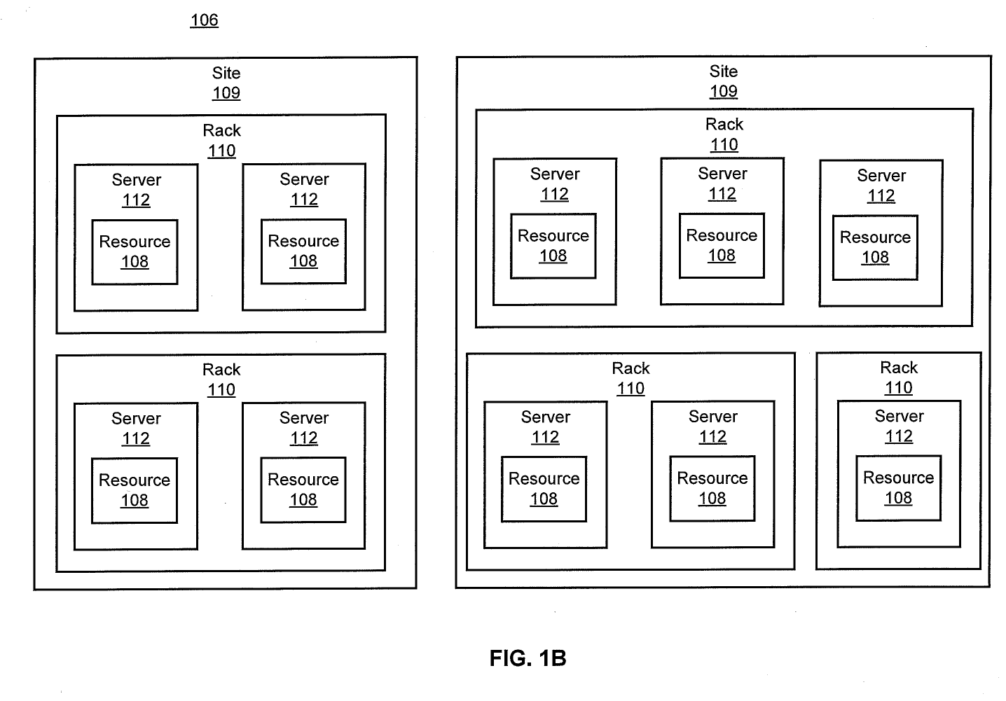

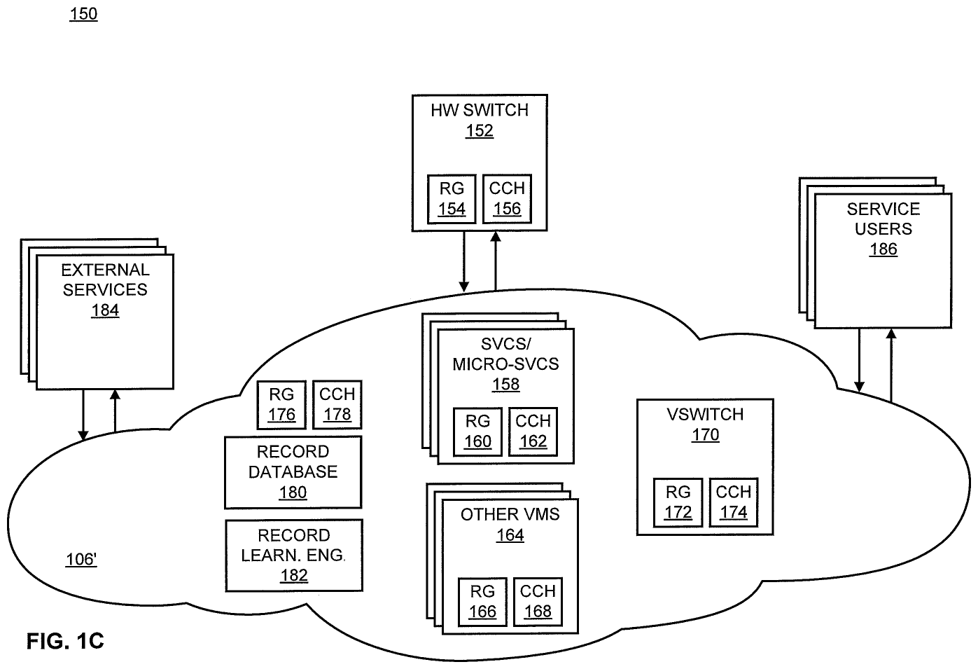

Turning to the drawings, FIG. 1A is a representation of an example network 100. Network 100 may include one or more applications (which in turn may include one or more virtual network functions (VNFs) implemented on general purpose hardware, such as in lieu of having dedicated hardware for every network function. That is, general purpose hardware of network 100 may be configured to run applications. In embodiments, general purpose hardware may be combined with special purpose hardware, within hardware platform 106, embodied as element 105, or distributed elsewhere within a network to which elements of FIG. 1A are communicatively coupled, to achieve particular functionality.

Each application 102 may use one or more VMs 104 or elements 105 to operate. Each VM 104 may have a VM type that indicates its functionality or role. Examples of VMs 104 include gateways (GWs), firewalls (FW), routers, real-time analytics, customer edges (vCEs), provider edges (vPEs), proxies, rendezvous points (RPs) or the like. Similarly, each element 105 may have an element type that indicates its functionality or role. Examples of elements 105 include an ingress point, an egress point, a non-virtualized function, or the like. While specific reference may be made to VMs 104 or groups (which may include one or more elements 105), this is for explanation to show that the deployment plan may not necessarily be limited to virtual components in all implementations. As noted earlier, while VMs are discussed for ease and consistency of explanation, this focus may be substituted by or supplemented with focus on containers. For example, one or more of VMs 104 or elements 105 can be a container. Similarly, various clients can be substituted for or comprise application 102, including but not limited to databases, webservers, media transcoders, other cloud applications, et cetera.

Each VM 104 may consume various network resources from a hardware platform 106, such as resources 108. For example, resources 108 may include one or more virtual central processing units (vCPUs), memory, or a network interface cards (MC). Resources 108 can be dedicated or commingled in support of one or more VM 104, with such utilization or assignment being performed dynamically, and need not conform to any particular arrangement (e.g., multiple CPUs can support one VM, multiple VMs can be supported by one CPU, et cetera). Various rules can be used in such allocation.

While FIG. 1A illustrates resources 108 as collectively contained in hardware platform 106, the configuration of hardware platform 106 may be further delineated. FIG. 1B provides an example implementation of hardware platform 106.

Hardware platform 106 may comprise one or more sites 109. For example, a site 109 may be a room, building, or geographic location in which resources 108 are located. For example, site 109 may be a datacenter. Each site 109 may comprise one or more racks 110. In an aspect, rack 110 may refer to the physical housing or platform for multiple servers or other network equipment. In an aspect, rack 110 may also refer to the underlying network equipment. Each rack 110 may include one or more servers 112. Server 112 may comprise general purpose computer hardware or a computer. In an aspect, rack 110 may comprise a metal rack, and servers 112 of rack 110 may comprise blade servers that are physically mounted in or on rack 110.

Each server 112 may include one or more network resources 108, as illustrated. Servers 112 may be communicatively coupled together (not shown) in any combination or arrangement. For example, all servers 112 within a given site 109 or rack 110 may be communicatively coupled. As another example, servers 112 in different racks 110 may be communicatively coupled. Additionally or alternatively, racks 110 may be communicatively coupled together (not shown) in any combination or arrangement.

The characteristics of each site 109, rack 110, and server 112 may differ. For example, the number of racks 110 within two sites 109 may vary, or the number of servers 112 within two racks 110 may vary. Additionally or alternatively, the type or number of resources 108 within each server 112 may vary. In an aspect, rack 110 may be used to group servers 112 with the same resource characteristics. In another aspect, servers 112 within the same rack 110 may have different resource characteristics.

A single application 102 may include many functional components (e.g., VMs 104 and elements 105. These components may have dependencies upon each other and inter-communication patterns with certain quality of service (QoS) requirements, such as locality, high availability, and security. Consequently, placement decisions—that is, decisions on how (and where) to implement VMs 104 and other elements 105 within hardware platform 106—may be based on all VMs 104 in which the components of application 102 run, including the dependencies of those VMs 104, holistically.

Such QoS requirements may be domain or application specific. Thus, a deployment plan for assigning resources 108 to VMs 104 of an application may depend upon certain limitations and requirements of both network 100 and application 102, such as the QoS requirements of a given application 102 and the underlying infrastructure of network 100. As all of this information is not typically accessible to both the application provider (that may not have access to network infrastructure details) and the cloud provider (that may not have access to the functionality of application 102), an abstraction may be used to create a deployment plan for application 102, where creation of the deployment plan can occur without knowledge or consideration of the specific infrastructure information.

A deployment plan may assign VMs 104 to particular resources 108 in accordance with one or more rules in order to account for the requirements of application 102 supported by such VMs 104. These rules may be based on abstracting the requirements of application 102, such as by levering the application provider's knowledge on its application 102 to yield a concise and flexible representation of the locality, availability, and security requirements of application 102 without needing to capture the specifics of the cloud infrastructure underlying network 100. The deployment plan may be based on one or more affinity rules, diversity (or anti-affinity) rules, exclusivity rules, or pipe rules. The deployment plan may further be based on nesting groupings (e.g., rules or sets of VMs 104). For example, the abstraction may provide for certain VMs 104 to be grouped together, so that rules may be applied to groups of VMs 104 or to individual VMs 104. A group may include one or more VMs 104, or other elements 105, such as ingress points, or the like. For example, FIG. 1A shows two example groups 107.

FIGS. 1A and 1B provide an environment for systems described herein, which can be include host systems, guest systems, or orchestration systems. In an example, VNFs implemented on such environments can include a virtual Mobility Management Entity (vMME), a virtual System Architecture Evolution with Packet Data Network Gateway and Serving Gateway (vSAEGW), a virtual Home Subscriber Server (vHSS), a virtual Diameter Routing Agent (vDRA), virtual firewall (vFW), virtual router (v-Router), et cetera, and other virtualized functions supporting wireless networks. VNFs can alternatively serve be non-architectural functions, including support of applications, proprietary or customer services, et cetera.

FIG. 1C illustrates an example system 150 for implementing east-west traffic monitoring as supported by environments like those of FIGS. 1A and 1B. FIG. 1C includes cloud 106′ which hosts a variety of virtualized nodes using hardware platform 106. While hardware switch 152 is shown separately from cloud 106′, it is understood that various other hardware (e.g., switches, gateways, servers providing compute or storage resources) can be utilized in conjunction with system 150 without departing from the scope or spirit of the innovation. More, hardware switch 152 may be a portion of hardware platform 106, or may be located among other hardware. Further, cloud 106′ can include resources (and therefore host virtualized nodes) in and from two or more data centers and other disparate resources.

Cloud 106′ hosts a variety of services (or micro-services) 158, and other VMs 164. These services 158 and/or VMs 164 have one or more addresses and associated hypervisors or managers, and one or more may exchange east-west traffic within cloud 106′. Hardware switch 152, virtual switch 170, and/or other switches are used for routing traffic between services 158 and/or VMs 164, as well as handling traffic from outside networks which can include, e.g., external services 184 and/or devices associated with services users 186 (which can be north-south traffic).

To capture information related to east-west traffic, cloud 106′ can include a record generator 176 and associated record cache 178. Record generator 176 configured to generate records, including east-west records, based on a traffic interaction at or with a node (e.g., services 158, VMs 164, virtual switch 170, and in embodiments other elements such as hardware switch 152, one or more of external services 184, and/or one or more devices associated with service users 186). The east-west record includes a source of the traffic (which can be the node or another node), a destination of the traffic (which can be the node or another node), a type of traffic (e.g., sensor data, chat app data, media player data, or any other types of traffic), and, where the node is a virtualized node, a hypervisor identifier or other information identifying management of the virtualized node. Record cache 178 is configured to store the east-west records on their generation. While shown separately for ease of explanation, record generator 176 and/or record cache 178 can be one or more services or micro-services among services 158, one or more VMs among VMs 164, or other virtual instances instantiated among other elements depicted in cloud 106′.

In embodiments, a node can be configured to generate and/or store records relating to itself In this regard, services 158 are illustrated to include an embodiment where one or more of services 158 includes record generator 160 and record cache 162; VMs 164 are illustrated to include an embodiment where one or more of VMs 164 includes record generator 166 and record cache 168; and virtual switch 170 is illustrated to include an embodiment where virtual switch includes record generator 172 and record cache 174. While each of record generators 160, 166, and 172 and record caches 162, 168, and 174 are illustrated as individual generators and caches, it is understood that two or more may exist among the various nodes, or within a single node, without departing from the scope or spirit of the innovation.

In embodiments, record generation is conducted at the switch-level, using one or more of record generator 154, record generator 172, and/or record generators at other switches to generate records relating to all traffic handled using a respective switch. Because switches possess routing or forwarding tables, the nodes (including dynamic virtual machines) with which they communicate can avoid providing certain information (e.g., identification and specification) as this can be discerned from tables possessed by the switches. Switch-level record generation allows for collection of records covering current scenarios for east-west traffic. In a first scenario, two or more VMs exchanging traffic are on the same physical machine, sharing the same switch and port group one that switch. A second scenario is similar but for two or more VMs exchanging traffic using different port groups. A third scenario is similar to the first but for the use of different switches (e.g., different virtual switches) despite using the same port group. A fourth scenario involves virtual machines exchanging traffic which do not share any common physical machine, port group, or switch. A fifth scenario is similar to the fourth but also provides that the virtual machines are hosted or supported by resources in disparate local area network (LAN) data centers. While speed and latency are impacted by these different scenarios, switch-level record generation allows for collection of all east-west traffic in each.

In alternative or complementary embodiments, a label can be placed on traffic traveling (e.g., in the form of a header) and virtual machines can populate or modify the label during transit. In embodiments, a hypervisor can provide the label.

One or more record caches of cloud 106′ can be stored in or using a peripheral memory device. For virtualized nodes, a peripheral memory device can be associated with a physical server supporting the virtualized node. For virtualized or hardware nodes, an associated record generator can, in embodiments, utilize a direct memory access flow to access the peripheral memory device (or record cache if not located on a peripheral memory device). Use of a peripheral memory device and/or direct memory access techniques can limit or avoid use of resources (e.g., compute, storage) otherwise supporting the network function of the node.

To limit resource consumption, or based on the constraints of a peripheral memory device, records stored in a given cache can be provided to record database 180. Records can be sent individually, or to reduce the number of transmissions, in batches. In embodiments, a cache can store records until it is full, reaches a threshold (e.g., 75% full, storage remaining for less than 1,000 additional records), or satisfies some other condition (e.g., 2 hours without a cache export), at which time the records are transmitted to record database 180. After transmitting the records to record database 180, or after confirmation that the records were received or confirmed readable by record database 180, a sending record cache can delete the sent records, or the sending cache can otherwise be cleared. While record database 180 is illustrated as single a standalone element in cloud 106′ for ease of explanation, it is understood that multiple record databases including record database 180 can be included in cloud 106′, and that record database 180 (or other record databases) can be virtual instances instantiated among services 158, VMs 164, or other virtualized elements of cloud 106′.

Record learning engine 182 accesses record database 180 (or other record databases) to analyze records stored therein. Record learning engine 182 can, in embodiments, identify patterns, determine key performance indicator (KPI) violations, define rule solutions, generate reports, or take action with respect to east-west traffic. Further, record learning engine 182 can include a forwarding table (e.g., from one or more virtual or hardware switches) to reassemble traffic (e.g., east-west traffic, east-west traffic and north-south traffic) into reports or for further analysis. The record learning engine 182 can further be configured to reconcile a record to identify faults, failures, or network conditions compromising traffic. An analyzed record is indicated reconciled if a corresponding record at a second node is located (indicating it originated at the expected node or was delivered to the intended node). On the other hand, a record is indicated failed if a corresponding record at a second node is not located (indicating an incorrect origin or delivery failure). While record learning engine 182 is illustrated as single a standalone element in cloud 106′ for ease of explanation, it is understood that multiple record learning engines including record learning engine 182 can be included in cloud 106′, and that record learning engine 182 (or other record learning engines) can be virtual instances instantiated among services 158, VMs 164, or other virtualized elements of cloud 106′.

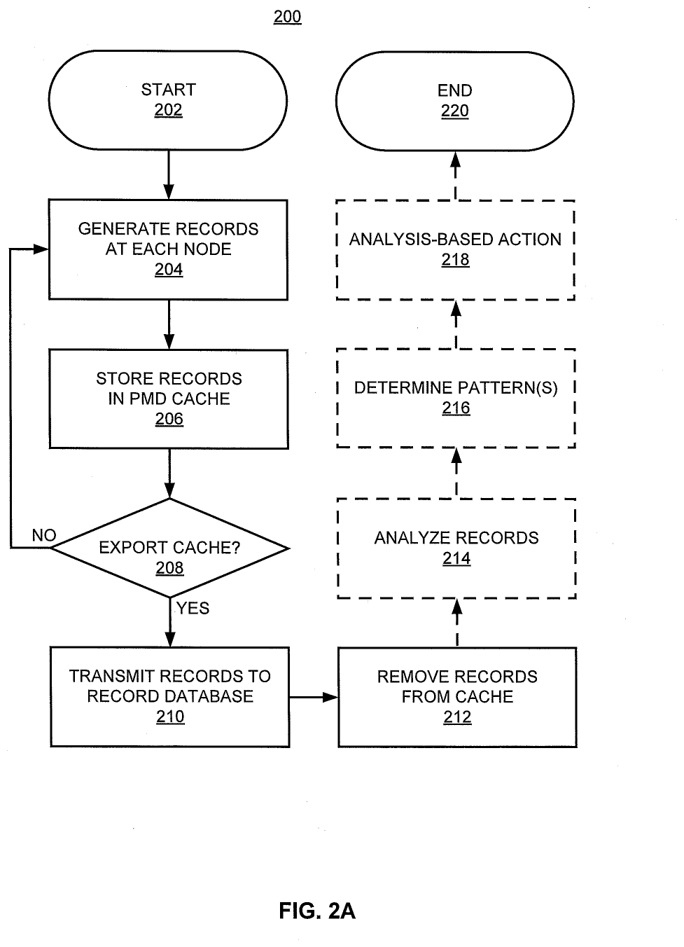

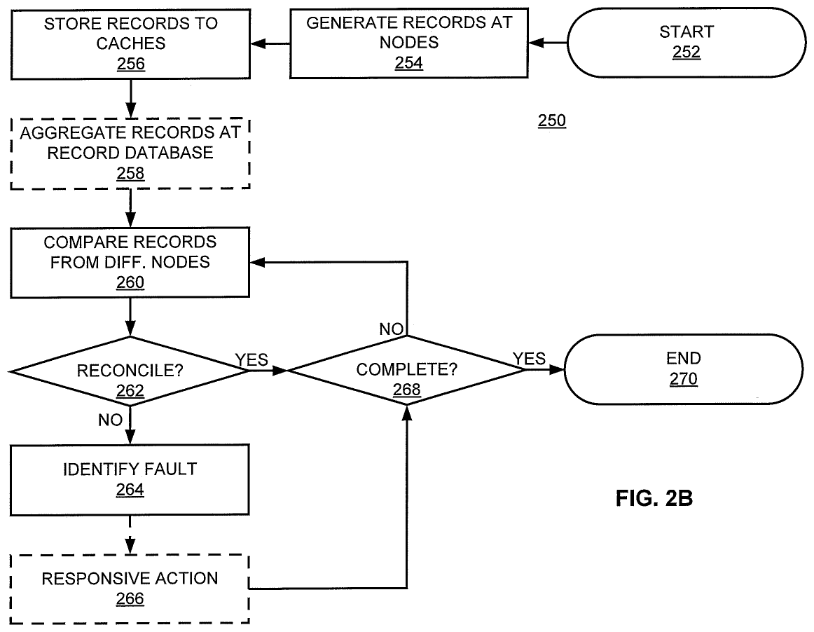

FIG. 2A illustrates a methodology 200 for implementing east-west monitoring. FIG. 2A begins at 202 and proceeds to 204 where records of traffic are generated at each node being monitored. Nodes being monitored can include virtualized nodes and non-virtualized nodes. The traffic for which records are generated includes east-west traffic. Each record contains information regarding traffic source, destination, and type. Records of traffic traveling to, from, or through a virtualized node can further include one or more hypervisor identifiers. Records can be generated by the node itself to which the record refers, or a switch (hardware or virtual) communicatively coupled with the node.

Thereafter, at 206, the generated records are stored in a record cache of a peripheral memory device associated with virtualized node. In embodiments, the node is a virtualized node and the record cache is associated with a physical server supporting the virtualized node. The record cache can store multiple records based on multiple traffic interactions at one or more nodes. In embodiments, memory supporting the cache can include a reserved portion for the cache, allowing other functionality using the peripheral memory device to proceed uninterrupted while ensuring cache capability.

In embodiments, a direct access memory flow can be used to access and write to the cache to limit or obviate the need for node resources. In embodiments, the direct memory access flow is performed using an expansion bus of a hardware server hosting the virtualized node. Such an expansion bus can include, e.g., a Peripheral Component Interconnect Express (PCIe) bus. In this manner, a node CPU (and/or shared compute resources) can be bypassed, providing the EWR directly to cache storage, preserving resources. In embodiments, a direct memory access driver can be provided to one or more components of cloud 106′ or underlying hardware 106. This varies from computer well-understood computer architectures which utilize an industry standard architecture (ISA) bus for inter-process activities. Because ISA buses are half-duplex, supporting one-way traffic, a CPU was required to manage bus traffic. In such architectures the CPU may also manage direct memory access controllers. In contrast buses used for embodiments using direct memory access in conjunction with system 150 support full-duplex (two-way traffic) and permits peripheral devices to communicate directly with RAM limiting or avoiding use of compute resources and local disk memory input/output (I/O) resources.

In embodiments using a PCIe bus, aspects described at 206 can include a variety of sub-aspects. Such sub-aspects can include a VM associated with a record sending a block data transfer request message (describing at least a size of a block for transfer) through an associated CPU along an ISA bus to a PCIe root complex. The PCIe root complex can forward the request using a PCIe switch to a peripheral memory device direct memory access driver (e.g., a PCIe endpoint). Thereafter, the direct memory access driver can receive the request and allocate a memory address satisfying the size on its phase change memory (PCM) (e.g., its nano-PCM). A confirmation can be returned to the VM, and the VM can push the block data onto the PCIe using RAM. This avoids use of the CPU in the transfer of the block data, and the full-duplex PCIe bus does not require CPU support to reduce traffic congestion.

At 208, a determination is made as to whether the cache is to be exported (e.g., below a remaining storage threshold, full and unable to store additional records, after expiration of a timer). If the determination at 208 returns negative, methodology 200 can recycle to, e.g., 204 where additional records are generated until the cache is full.

If the determination at 208 returns positive, methodology 200 proceeds to 210 where the records are transmitted from the cache to a record database.

After transmitting the records to the database, at 212, the transmitted records are removed from the cache. In embodiments, a confirmation of receipt, a confirmation of readability, or other indicator of successful receipt by the record database can be provided or acknowledged prior to removing any records from the cache. In embodiments, the entire cache can be cleared. In embodiments, the cache can continue receiving new records after the determination at 208 returns positive (using, e.g., a threshold which preserves cache space for additional records by causing export of the records before the cache is completely full) and only those records transmitted are removed from the cache with records generated after the transmission triggered by the determination at 208 are retained in the cache for later transmission.

Various additional actions can follow collection of records, including east-west records, in a record database. For example, at 214 records can be analyzed (e.g., statistical analysis, using artificial intelligence/machine learning). Analysis can provide information on the health of VMs or hardware nodes; identify faults, failures, and incorrect lifecycle transitions (e.g., during instantiation, modification, or destruction of a VM); determine the efficiencies of inter-process communications as defined by, e.g., latency, usage levels, idle time; and correlate network events to traffic patterns or KPIs.

Thereafter at 216, patterns can be ascertained based on the analysis. Based on the analysis at 214 or patterns determined at 216, analysis-based action can be taken at 218. Analysis-based action can include, but is not limited to, solving, modifying, or deploying rules to various nodes (e.g., load balancers, API gateways, physical switches, virtual switches, firewalls) based on insights learned from EWRs; generating summaries or traffic documents, files, or pages; generating imagery representing traffic or traffic patterns; reconciling reports; scaling resources up or down; performing load balancing action; providing notifications to services or users; et cetera. Global behavior, vendor behavior, customer behavior or interactions, brand cost or revenue, and other statistical values can be generated from pattern discovery.

In embodiments, at 216, a forwarding table (associated with a hardware or virtual switch) can be used to reassemble traffic, and in embodiments a traffic model can be generated from a plurality of records using the forwarding table. Thereafter, at 220, methodology 200 ends.

FIG. 2B illustrates another methodology 250 for implementing east-west traffic monitoring. Methodology 250 begins at 252 and proceeds to 254 where records, including east-west records, are generated at nodes. In embodiments, records (including one or both of east-west records and north-south records) may be generated at another network location other than the node. At 256, the records are stored to caches. In embodiments, at 258, the records from or relating to multiple nodes can be aggregated at a record database.

At 260, two or more corresponding records from or associated with different nodes can be compared for reconciliation. In embodiments, these records are inspected as stored in one or more record databases. In alternative embodiments, these records may be inspected in one or more caches. Inspection and/or analysis can include reassembly of traffic by using a forwarding table (e.g., associated with a hardware or virtual switch).

At 262, the inspected records are analyzed to determine whether two or more records can be reconciled. If the path of the traffic can be traced from a first origin to a final destination by matching “sent” and “received” records, the records are reconciled and methodology 250 proceeds to 268 where a check is completed to determine whether reconciliation of records is complete.

If the determination at 262 returns negative, methodology 250 proceeds to 264 where a fault can be identified. The fault can indicate a transmission issue, node issue, network condition, or other cause or circumstance related to the reconciliation failure. In embodiments, at 266, responsive action can be taken in response to the identified fault (e.g., scale up resources to restore network QoS). Thereafter methodology proceeds to 268.

If the determination at 268 indicates that reconciliation of records is not complete, methodology 250 returns to 260 where comparison of records continues. Alternatively methodology 250 can recycle to another point, such as 254. If the determination at 268 returns positive, methodology 250 proceeds to end at 270.

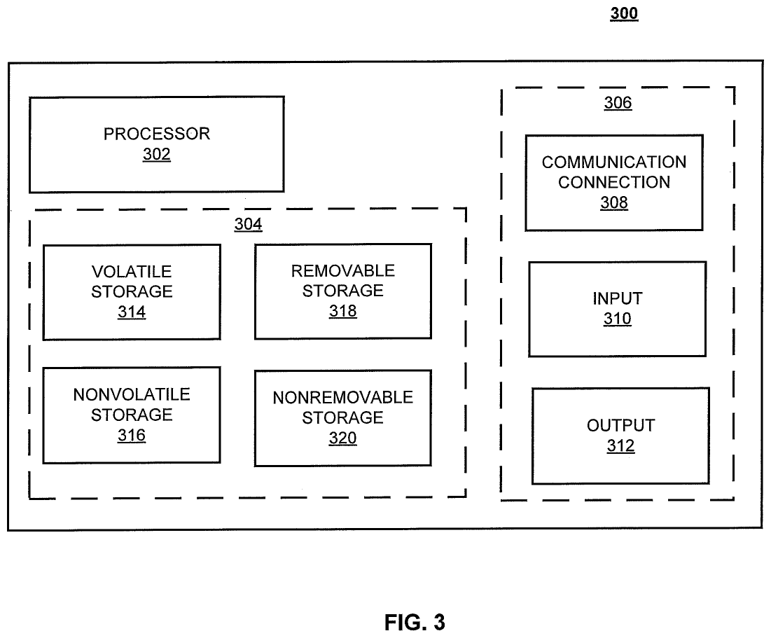

FIG. 3 is a block diagram of network device 300 that may be connected to or comprise a component of network 100. For example, network device 300 may implement one or more portions of methodology 200 for placement of network components of application 102. Network device 300 may comprise hardware or a combination of hardware and software. The functionality to facilitate telecommunications via a telecommunications network may reside in one or combination of network devices 300. Network device 300 depicted in FIG. 3 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an ALFS, a gateway mobile location center (GMLC), a radio access network (RAN), a serving mobile location center (SMLC), or the like, or any appropriate combination thereof It is emphasized that the block diagram depicted in FIG. 3 is example and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength. As evident from the description herein, network device 300 is not to be construed as software per se.

In addition to processor 302 and memory 304, network device 300 may include an input/output system 306. Processor 302, memory 304, and input/output system 306 may be coupled together (coupling not shown in FIG. 3) to allow communications there between. Each portion of network device 300 may comprise circuitry for performing functions associated with each respective portion. Thus, each portion may comprise hardware, or a combination of hardware and software. Accordingly, each portion of network device 300 is not to be construed as software per se. Input/output system 306 may be capable of receiving or providing information from or to a communications device or other network entities configured for telecommunications. For example input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

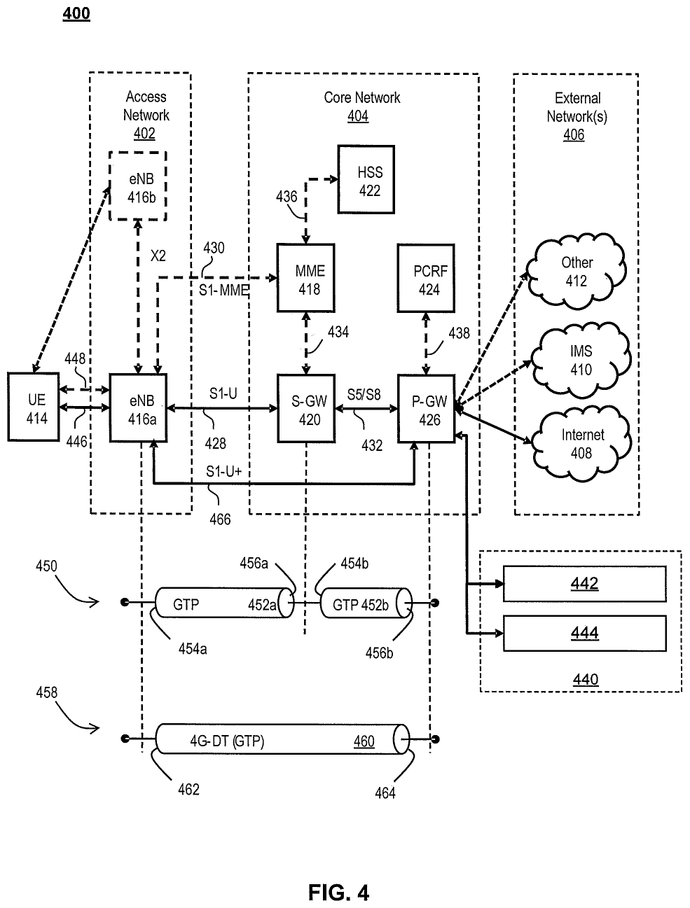

FIG. 4 illustrates a functional block diagram depicting one example of an LTE-EPS network architecture 400 that may be at least partially implemented as using virtualized functions. Network architecture 400 disclosed herein is referred to as a modified LTE-EPS architecture 400 to distinguish it from a traditional LTE-EPS architecture. While aspects of FIG. 4 and accompanying of network architecture 400 are discussed in relation to LTE, it is expressly noted that aspects herein can be alternatively or complementarily implemented in 5G (or other) network architectures without departing from the scope or spirit of the innovation.

An example modified LTE-EPS architecture 400 is based at least in part on standards developed by the 3rd Generation Partnership Project (3GPP), with information available at www.3gpp.org. LTE-EPS network architecture 400 may include an access network 402, a core network 404, e.g., an EPC or Common BackBone (CBB) and one or more external networks 406, sometimes referred to as PDN or peer entities. Different external networks 406 can be distinguished from each other by a respective network identifier, e.g., a label according to domain name system (DNS) naming conventions describing an access point to the PDN. Such labels can be referred to as Access Point Names (APN). External networks 406 can include one or more trusted and non-trusted external networks such as an internet protocol (IP) network 408, an IP multimedia subsystem (IMS) network 410, and other networks 412, such as a service network, a corporate network, or the like. In an aspect, access network 402, core network 404, or external network 405 may include or communicate with network 100.

Access network 402 can include an LTE network architecture sometimes referred to as Evolved Universal mobile Telecommunication system Terrestrial Radio Access (E UTRA) and evolved UMTS Terrestrial Radio Access Network (E-UTRAN). Broadly, access network 402 can include one or more communication devices, commonly referred to as UE 414, and one or more wireless access nodes, or base stations 416a, 416b. During network operations, at least one base station 416 communicates directly with UE 414. Base station 416 can be an evolved Node B (e-NodeB), with which UE 414 communicates over the air and wirelessly. UEs 414 can include, without limitation, wireless devices, e.g., satellite communication systems, portable digital assistants (PDAs), laptop computers, tablet devices and other mobile devices (e.g., cellular telephones, smart appliances, and so on). UEs 414 can connect to eNBs 416 when UE 414 is within range according to a corresponding wireless communication technology.

UE 414 generally runs one or more applications that engage in a transfer of packets between UE 414 and one or more external networks 406. Such packet transfers can include one of downlink packet transfers from external network 406 to UE 414, uplink packet transfers from UE 414 to external network 406 or combinations of uplink and downlink packet transfers. Applications can include, without limitation, web browsing, VoIP, streaming media and the like. Each application can pose different Quality of Service requirements on a respective packet transfer. Different packet transfers can be served by different bearers within core network 404, e.g., according to parameters, such as the QoS.

Core network 404 uses a concept of bearers, e.g., EPS bearers, to route packets, e.g., IP traffic, between a particular gateway in core network 404 and UE 414. A bearer refers generally to an IP packet flow with a defined QoS between the particular gateway and UE 414. Access network 402, e.g., E UTRAN, and core network 404 together set up and release bearers as required by the various applications. Bearers can be classified in at least two different categories: (i) minimum guaranteed bit rate bearers, e.g., for applications, such as VoIP; and (ii) non-guaranteed bit rate bearers that do not require guarantee bit rate, e.g., for applications, such as web browsing.

In one embodiment, the core network 404 includes various network entities, such as mobility management entity (MME) 418, SGW 420, Home Subscriber Server (HSS) 422, Policy and Charging Rules Function (PCRF) 424 and PGW 426. In one embodiment, MME 418 comprises a control node performing a control signaling between various equipment and devices in access network 402 and core network 404. The protocols running between UE 414 and core network 404 are generally known as Non-Access Stratum (NAS) protocols.

For illustration purposes only, the terms MME 418, SGW 420, HSS 422 and PGW 426, and so on, can be server devices, but may be referred to in the subject disclosure without the word “server.” It is also understood that any form of such servers can operate in a device, system, component, or other form of centralized or distributed hardware and software. It is further noted that these terms and other terms such as bearer paths and/or interfaces are terms that can include features, methodologies, and/or fields that may be described in whole or in part by standards bodies such as the 3GPP. It is further noted that some or all embodiments of the subject disclosure may in whole or in part modify, supplement, or otherwise supersede final or proposed standards published and promulgated by 3GPP.

According to traditional implementations of LTE-EPS architectures, SGW 420 routes and forwards all user data packets. SGW 420 also acts as a mobility anchor for user plane operation during handovers between base stations, e.g., during a handover from first eNB 416a to second eNB 416b as may be the result of UE 414 moving from one area of coverage, e.g., cell, to another. SGW 420 can also terminate a downlink data path, e.g., from external network 406 to UE 414 in an idle state, and trigger a paging operation when downlink data arrives for UE 414. SGW 420 can also be configured to manage and store a context for UE 414, e.g., including one or more of parameters of the IP bearer service and network internal routing information. In addition, SGW 420 can perform administrative functions, e.g., in a visited network, such as collecting information for charging (e.g., the volume of data sent to or received from the user), and/or replicate user traffic, e.g., to support a lawful interception. SGW 420 also serves as the mobility anchor for interworking with other 3GPP technologies such as universal mobile telecommunication system (UMTS).

At any given time, UE 414 is generally in one of three different states: detached, idle, or active. The detached state is typically a transitory state in which UE 414 is powered on but is engaged in a process of searching and registering with network 402. In the active state, UE 414 is registered with access network 402 and has established a wireless connection, e.g., radio resource control (RRC) connection, with eNB 416. Whether UE 414 is in an active state can depend on the state of a packet data session, and whether there is an active packet data session. In the idle state, UE 414 is generally in a power conservation state in which UE 414 typically does not communicate packets. When UE 414 is idle, SGW 420 can terminate a downlink data path, e.g., from one peer entity, and triggers paging of UE 414 when data arrives for UE 414. If UE 414 responds to the page, SGW 420 can forward the IP packet to eNB 416a.

HSS 422 can manage subscription-related information for a user of UE 414. For example, tHSS 422 can store information such as authorization of the user, security requirements for the user, quality of service requirements for the user, et cetera. HSS 422 can also hold information about external networks 406 to which the user can connect, e.g., in the form of an APN of external networks 406. For example, MME 418 can communicate with HSS 422 to determine if UE 414 is authorized to establish a call, e.g., a voice over IP (VoIP) call before the call is established.

PCRF 424 can perform QoS management functions and policy control. PCRF 424 is responsible for policy control decision-making, as well as for controlling the flow-based charging functionalities in a policy control enforcement function (PCEF), which resides in PGW 426. PCRF 424 provides the QoS authorization, e.g., QoS class identifier and bit rates that decide how a certain data flow will be treated in the PCEF and ensures that this is in accordance with the user's subscription profile.

PGW 426 can provide connectivity between the UE 414 and one or more of the external networks 406. In illustrative network architecture 400, PGW 426 can be responsible for IP address allocation for UE 414, as well as one or more of QoS enforcement and flow-based charging, e.g., according to rules from the PCRF 424. PGW 426 is also typically responsible for filtering downlink user IP packets into the different QoS-based bearers. In at least some embodiments, such filtering can be performed based on traffic flow templates. PGW 426 can also perform QoS enforcement, e.g., for guaranteed bit rate bearers. PGW 426 also serves as a mobility anchor for interworking with non-3GPP technologies such as CDMA2000.

Within access network 402 and core network 404 there may be various bearer paths/interfaces, e.g., represented by solid lines 428 and 430. Some of the bearer paths can be referred to by a specific label. For example, solid line 428 can be considered an S1-U bearer and solid line 432 can be considered an S5/S8 bearer according to LTE-EPS architecture standards. Without limitation, reference to various interfaces, such as S1, X2, S5, S8, S11 refer to EPS interfaces. In some instances, such interface designations are combined with a suffix, e.g.; a “U” or a “C” to signify whether the interface relates to a “User plane” or a “Control plane.” In addition, the core network 404 can include various signaling bearer paths/interfaces, e.g., control plane paths/interfaces represented by dashed lines 430, 434, 436, and 438. Some of the signaling bearer paths may be referred to by a specific label. For example, dashed line 430 can be considered as an S1-MME signaling bearer, dashed line 434 can be considered as an S11 signaling bearer and dashed line 436 can be considered as an S6a signaling bearer, e.g., according to LTE-EPS architecture standards. The above bearer paths and signaling bearer paths are only illustrated as examples and it should be noted that additional bearer paths and signaling bearer paths may exist that are not illustrated.

Also shown is a novel user plane path/interface, referred to as the S1-U+ interface 466. In the illustrative example, the S1-U+ user plane interface extends between the eNB 416a and PGW 426. Notably, S1-U+ path/interface does not include SGW 420, a node that is otherwise instrumental in configuring and/or managing packet forwarding between eNB 416a and one or more external networks 406 by way of PGW 426. As disclosed herein, the S1-U+ path/interface facilitates autonomous learning of peer transport layer addresses by one or more of the network nodes to facilitate a self-configuring of the packet forwarding path. In particular, such self-configuring can be accomplished during handovers in most scenarios so as to reduce any extra signaling load on the S/PGWs 420, 426 due to excessive handover events.

In some embodiments, PGW 426 is coupled to storage device 440, shown in phantom. Storage device 440 can be integral to one of the network nodes, such as PGW 426, for example, in the form of internal memory and/or disk drive. It is understood that storage device 440 can include registers suitable for storing address values. Alternatively or in addition, storage device 440 can be separate from PGW 426, for example, as an external hard drive, a flash drive, and/or network storage.

Storage device 440 selectively stores one or more values relevant to the forwarding of packet data. For example, storage device 440 can store identities and/or addresses of network entities, such as any of network nodes 418, 420, 422, 424, and 426, eNBs 416 and/or UE 414. In the illustrative example, storage device 440 includes a first storage location 442 and a second storage location 444. First storage location 442 can be dedicated to storing a Currently Used Downlink address value 442. Likewise, second storage location 444 can be dedicated to storing a Default Downlink Forwarding address value 444. PGW 426 can read and/or write values into either of storage locations 442, 444, for example, managing Currently Used Downlink Forwarding address value 442 and Default Downlink Forwarding address value 444 as disclosed herein.

In some embodiments, the Default Downlink Forwarding address for each EPS bearer is the SGW S5-U address for each EPS Bearer. The Currently Used Downlink Forwarding address” for each EPS bearer in PGW 426 can be set every time when PGW 426 receives an uplink packet, e.g., a GTP-U uplink packet, with a new source address for a corresponding EPS bearer. When UE 414 is in an idle state, the “Current Used Downlink Forwarding address” field for each EPS bearer of UE 414 can be set to a “null” or other suitable value.

In some embodiments, the Default Downlink Forwarding address is only updated when PGW 426 receives a new SGW S5-U address in a predetermined message or messages. For example, the Default Downlink Forwarding address is only updated when PGW 426 receives one of a Create Session Request, Modify Bearer Request and Create Bearer Response messages from SGW 420.

As values 442, 444 can be maintained and otherwise manipulated on a per bearer basis, it is understood that the storage locations can take the form of tables, spreadsheets, lists, and/or other data structures generally well understood and suitable for maintaining and/or otherwise manipulate forwarding addresses on a per bearer basis.

It should be noted that access network 402 and core network 404 are illustrated in a simplified block diagram in FIG. 4. In other words, either or both of access network 402 and the core network 404 can include additional network elements that are not shown, such as various routers, switches and controllers. In addition, although FIG. 4 illustrates only a single one of each of the various network elements, it should be noted that access network 402 and core network 404 can include any number of the various network elements. For example, core network 404 can include a pool (i.e., more than one) of MMEs 418, SGWs 420 or PGWs 426.

In the illustrative example, data traversing a network path between UE 414, eNB 416a, SGW 420, PGW 426 and external network 406 may be considered to constitute data transferred according to an end-to-end IP service. However, for the present disclosure, to properly perform establishment management in LTE-EPS network architecture 400, the core network, data bearer portion of the end-to-end IP service is analyzed.

An establishment may be defined herein as a connection set up request between any two elements within LTE-EPS network architecture 400. The connection set up request may be for user data or for signaling. A failed establishment may be defined as a connection set up request that was unsuccessful. A successful establishment may be defined as a connection set up request that was successful.

In one embodiment, a data bearer portion comprises a first portion (e.g., a data radio bearer 446) between UE 414 and eNB 416a, a second portion (e.g., an S1 data bearer 428) between eNB 416a and SGW 420, and a third portion (e.g., an S5/S8 bearer 432) between SGW 420 and PGW 426. Various signaling bearer portions are also illustrated in FIG. 4. For example, a first signaling portion (e.g., a signaling radio bearer 448) between UE 414 and eNB 416a, and a second signaling portion (e.g., S1 signaling bearer 430) between eNB 416a and MME 418.

In at least some embodiments, the data bearer can include tunneling, e.g., IP tunneling, by which data packets can be forwarded in an encapsulated manner, between tunnel endpoints. Tunnels, or tunnel connections can be identified in one or more nodes of network 100, e.g., by one or more of tunnel endpoint identifiers, an IP address and a user datagram protocol port number. Within a particular tunnel connection, payloads, e.g., packet data, which may or may not include protocol related information, are forwarded between tunnel endpoints.

An example of first tunnel solution 450 includes a first tunnel 452a between two tunnel endpoints 454a and 456a, and a second tunnel 452b between two tunnel endpoints 454b and 456b. In the illustrative example, first tunnel 452a is established between eNB 416a and SGW 420. Accordingly, first tunnel 452a includes a first tunnel endpoint 454a corresponding to an S1-U address of eNB 416a (referred to herein as the eNB S1-U address), and second tunnel endpoint 456a corresponding to an S1-U address of SGW 420 (referred to herein as the SGW S1-U address). Likewise, second tunnel 452b includes first tunnel endpoint 454b corresponding to an S5-U address of SGW 420 (referred to herein as the SGW S5-U address), and second tunnel endpoint 456b corresponding to an S5-U address of PGW 426 (referred to herein as the PGW S5-U address).

In at least some embodiments, first tunnel solution 450 is referred to as a two tunnel solution, e.g., according to the GPRS Tunneling Protocol User Plane (GTPv1-U based), as described in 3GPP specification TS 29.281, incorporated herein in its entirety. It is understood that one or more tunnels are permitted between each set of tunnel end points. For example, each subscriber can have one or more tunnels, e.g., one for each PDP context that they have active, as well as possibly having separate tunnels for specific connections with different quality of service requirements, and so on.

An example of second tunnel solution 458 includes a single or direct tunnel 460 between tunnel endpoints 462 and 464. In the illustrative example, direct tunnel 460 is established between eNB 416a and PGW 426, without subjecting packet transfers to processing related to SGW 420. Accordingly, direct tunnel 460 includes first tunnel endpoint 462 corresponding to the eNB S1-U address, and second tunnel endpoint 464 corresponding to the PGW S5-U address. Packet data received at either end can be encapsulated into a payload and directed to the corresponding address of the other end of the tunnel. Such direct tunneling avoids processing, e.g., by SGW 420 that would otherwise relay packets between the same two endpoints, e.g., according to a protocol, such as the GTP-U protocol.

In some scenarios, direct tunneling solution 458 can forward user plane data packets between eNB 416a and PGW 426, by way of SGW 420. That is, SGW 420 can serve a relay function, by relaying packets between two tunnel endpoints 416a, 426. In other scenarios, direct tunneling solution 458 can forward user data packets between eNB 416a and PGW 426, by way of the S1 U+ interface, thereby bypassing SGW 420.

Generally, UE 414 can have one or more bearers at any one time. The number and types of bearers can depend on applications, default requirements, and so on. It is understood that the techniques disclosed herein, including the configuration, management and use of various tunnel solutions 450, 458, can be applied to the bearers on an individual bases. That is, if user data packets of one bearer, say a bearer associated with a VoIP service of UE 414, then the forwarding of all packets of that bearer are handled in a similar manner Continuing with this example, the same UE 414 can have another bearer associated with it through the same eNB 416a. This other bearer, for example, can be associated with a relatively low rate data session forwarding user data packets through core network 404 simultaneously with the first bearer. Likewise, the user data packets of the other bearer are also handled in a similar manner, without necessarily following a forwarding path or solution of the first bearer. Thus, one of the bearers may be forwarded through direct tunnel 458; whereas, another one of the bearers may be forwarded through a two-tunnel solution 450.

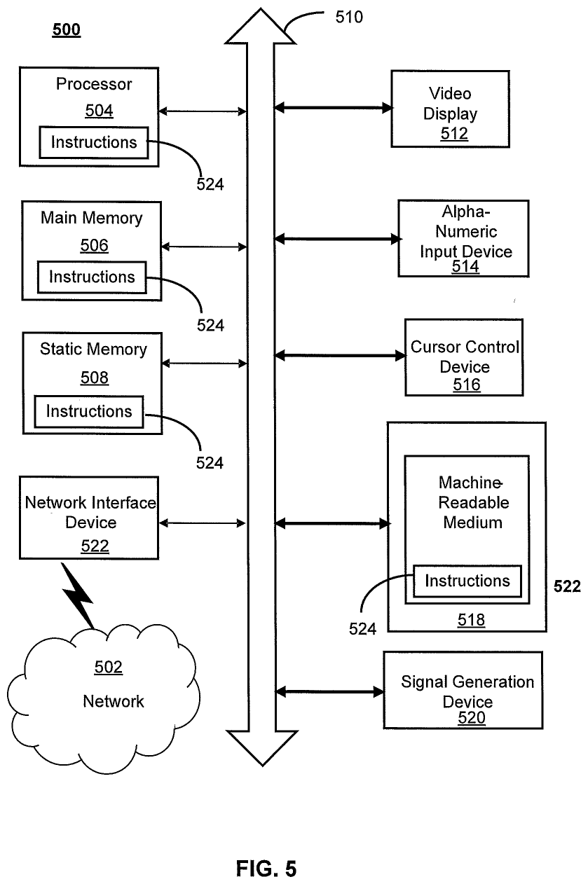

FIG. 5 depicts an example diagrammatic representation of a machine in the form of a computer system 500 within which a set of instructions, when executed, may cause the machine to perform any one or more of the methods described above. One or more instances of the machine can operate, for example, as processor 302, UE 414, eNB 416, MME 418, SGW 420, HSS 422, PCRF 424, PGW 426 and other devices of FIGS. 1, 2, and 4. In some embodiments, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the embodiments described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium 524 on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

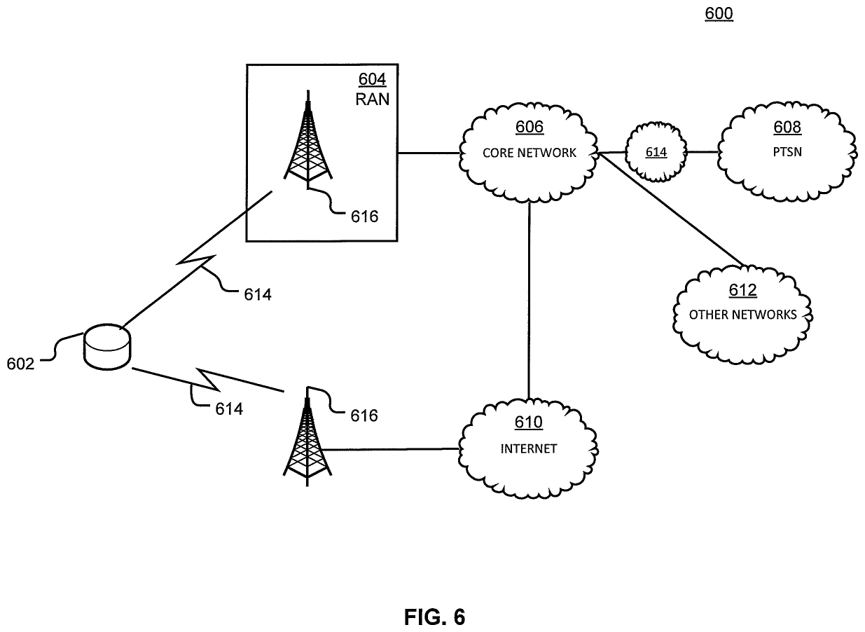

As shown in FIG. 6, telecommunication system 600 may include wireless transmit/receive units (WTRUs) 602, a RAN 604, a core network 606, a public switched telephone network (PSTN) 608, the Internet 610, or other networks 612, though it will be appreciated that the disclosed examples contemplate any number of WTRUs, base stations, networks, or network elements. Each WTRU 602 may be any type of device configured to operate or communicate in a wireless environment. For example, a WTRU may comprise a mobile device, network device 300, or the like, or any combination thereof. By way of example, WTRUs 602 may be configured to transmit or receive wireless signals and may include a UE, a mobile station, a mobile device, a fixed or mobile subscriber unit, a pager, a cellular telephone, a PDA, a smartphone, a laptop, a netbook, a personal computer, a wireless sensor, consumer electronics, or the like. WTRUs 602 may be configured to transmit or receive wireless signals over an air interface 614. As with other portions of this disclosure, while aspects relating to FIG. 6 are at times described in relation to LTE architectures, 5G architectures (and others) may be incorporated or utilized without departing from the scope or spirit of the innovation.

Telecommunication system 600 may also include one or more base stations 616. Each of base stations 616 may be any type of device configured to wirelessly interface with at least one of the WTRUs 602 to facilitate access to one or more communication networks, such as core network 606, PTSN 608, Internet 610, or other networks 612. By way of example, base stations 616 may be a base transceiver station (BTS), a Node-B, an eNode B, a Home Node B, a Home eNode B, a site controller, an access point (AP), a wireless router, or the like. While base stations 616 are each depicted as a single element, it will be appreciated that base stations 616 may include any number of interconnected base stations or network elements.

RAN 604 may include one or more base stations 616, along with other network elements (not shown), such as a base station controller (BSC), a radio network controller (RNC), or relay nodes. One or more base stations 616 may be configured to transmit or receive wireless signals within a particular geographic region, which may be referred to as a cell (not shown). The cell may further be divided into cell sectors. For example, the cell associated with base station 616 may be divided into three sectors such that base station 616 may include three transceivers: one for each sector of the cell. In another example, base station 616 may employ multiple-input multiple-output (MIMO) technology and, therefore, may utilize multiple transceivers for each sector of the cell.

Base stations 616 may communicate with one or more of WTRUs 602 over air interface 614, which may be any suitable wireless communication link (e.g., RF, microwave, infrared (IR), ultraviolet (UV), or visible light). Air interface 614 may be established using any suitable radio access technology (RAT).

More specifically, as noted above, telecommunication system 600 may be a multiple access system and may employ one or more channel access schemes, such as CDMA, TDMA, FDMA, OFDMA, SC-FDMA, or the like. For example, base station 616 in RAN 604 and WTRUs 602 connected to RAN 604 may implement a radio technology such as Universal Mobile Telecommunications System (UMTS) Terrestrial Radio Access (UTRA) that may establish air interface 614 using wideband CDMA (WCDMA). WCDMA may include communication protocols, such as High-Speed Packet Access (HSPA) or Evolved HSPA (HSPA+). HSPA may include High-Speed Downlink Packet Access (HSDPA) or High-Speed Uplink Packet Access (HSUPA).

As another example base station 616 and WTRUs 602 that are connected to RAN 604 may implement a radio technology such as Evolved UMTS Terrestrial Radio Access (E-UTRA), which may establish air interface 614 using L or LTE-Advanced (LTE-A).

Optionally base station 616 and WTRUs 602 connected to RAN 604 may implement radio technologies such as IEEE 602.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), GSM, Enhanced Data rates for GSM Evolution (EDGE), GSM EDGE (GERAN), or the like.

Base station 616 may be a wireless router, Home Node B, Home eNode B, or access point, for example, and may utilize any suitable RAT for facilitating wireless connectivity in a localized area, such as a place of business, a home, a vehicle, a campus, or the like. For example, base station 616 and associated WTRUs 602 may implement a radio technology such as IEEE 602.11 to establish a wireless local area network (WLAN). As another example, base station 616 and associated WTRUs 602 may implement a radio technology such as IEEE 602.15 to establish a wireless personal area network (WPAN). In yet another example, base station 616 and associated WTRUs 602 may utilize a cellular-based RAT (e.g., WCDMA, CDMA2000, GSM, LTE, LTE-A, et cetera) to establish a picocell or femtocell. As shown in FIG. 6, base station 616 may have a direct connection to Internet 610. Thus, base station 616 may not be required to access Internet 610 via core network 606.

RAN 604 may be in communication with core network 606, which may be any type of network configured to provide voice, data, applications, and/or voice over internet protocol (VoIP) services to one or more WTRUs 602. For example, core network 606 may provide call control, billing services, mobile location-based services, pre-paid calling, Internet connectivity, video distribution or high-level security functions, such as user authentication. Although not shown in FIG. 6, it will be appreciated that RAN 604 or core network 606 may be in direct or indirect communication with other RANs that employ the same RAT as RAN 604 or a different RAT. For example, in addition to being connected to RAN 604, which may be utilizing an E-UTRA radio technology, core network 606 may also be in communication with another RAN (not shown) employing a GSM radio technology.

Core network 606 may also serve as a gateway for WTRUs 602 to access PSTN 608, Internet 610, or other networks 612. PSTN 608 may include circuit-switched telephone networks that provide plain old telephone service (POTS). For LTE core networks, core network 606 may use IMS core 614 to provide access to PSTN 608. Internet 610 may include a global system of interconnected computer networks or devices that use common communication protocols, such as the transmission control protocol (TCP), user datagram protocol (UDP), or IP in the TCP/IP internet protocol suite. Other networks 612 may include wired or wireless communications networks owned or operated by other service providers. For example, other networks 612 may include another core network connected to one or more RANs, which may employ the same RAT as RAN 604 or a different RAT.

Some or all WTRUs 602 in telecommunication system 600 may include multi-mode capabilities. That is, WTRUs 602 may include multiple transceivers for communicating with different wireless networks over different wireless links. For example, one or more W RUs 602 may be configured to communicate with base station 616, which may employ a cellular-based radio technology, and with base station 616, which may employ an IEEE 802 radio technology.

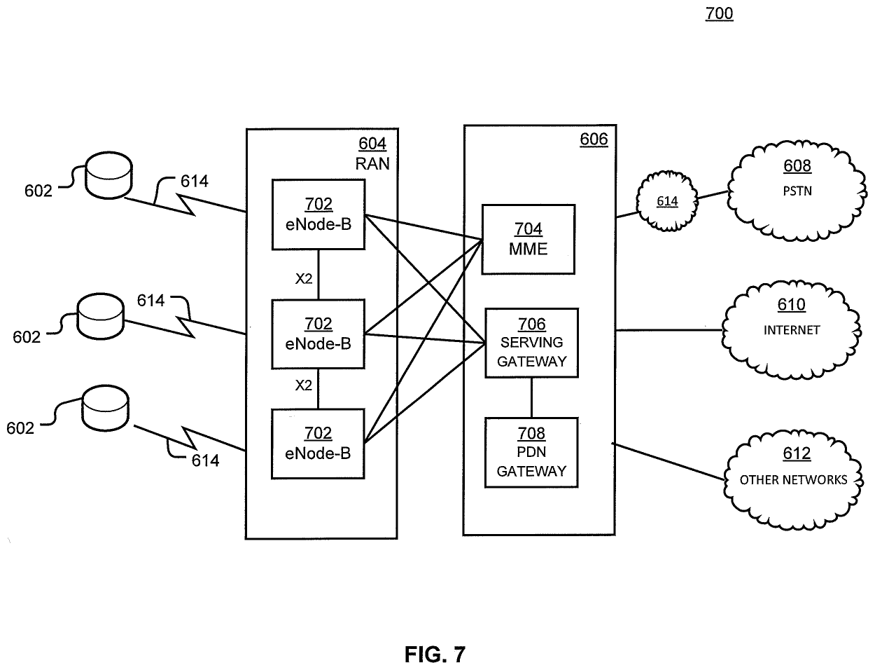

FIG. 7 is an example system 700 including RAN 604 and core network 606. As noted above, RAN 604 may employ an E-UTRA radio technology to communicate with WTRUs 602 over air interface 614. RAN 604 may also be in communication with core network 606.

RAN 604 may include any number of eNode-Bs 702 while remaining consistent with the disclosed technology. One or more eNode-Bs 702 may include one or more transceivers for communicating with the WTRUs 602 over air interface 614. Optionally, eNode-Bs 702 may implement MIMO technology. Thus, one of eNode-Bs 702, for example, may use multiple antennas to transmit wireless signals to, or receive wireless signals from, one of WIRUs 602.

Each of eNode-Bs 702 may be associated with a particular cell (not shown) and may be configured to handle radio resource management decisions, handover decisions, scheduling of users in the uplink or downlink, or the like. As shown in FIG. 7 eNode-Bs 702 may communicate with one another over an X2 interface.

Core network 606 shown in FIG. 7 may include a mobility management gateway or entity (MME) 704, a serving gateway 706, or a packet data network (PDN) gateway 708. While each of the foregoing elements are depicted as part of core network 606, it will be appreciated that any one of these elements may be owned or operated by an entity other than the core network operator.

MME 704 may be connected to each of eNode-Bs 702 in RAN 604 via an S1 interface and may serve as a control node. For example, MME 704 may be responsible for authenticating users of WTRUs 602, bearer activation or deactivation, selecting a particular serving gateway during an initial attach of WTRUs 602, or the like. MME 704 may also provide a control plane function for switching between RAN 604 and other RANs (not shown) that employ other radio technologies, such as GSM or WCDMA.

Serving gateway 706 may be connected to each of eNode-Bs 702 in RAN 604 via the S1 interface. Serving gateway 706 may generally route or forward user data packets to or from the WTRUs 602. Serving gateway 706 may also perform other functions, such as anchoring user planes during inter-eNode B handovers, triggering paging when downlink data is available for WTRUs 602, managing or storing contexts of WTRUs 602, or the like.

Serving gateway 706 may also be connected to PDN gateway 708, which may provide WTRUs 602 with access to packet-switched networks, such as Internet 610, to facilitate communications between WTRUs 602 and IP-enabled devices.

Core network 606 may facilitate communications with other networks. For example, core network 606 may provide WTRUs 602 with access to circuit-switched networks, such as PSTN 608, such as through IMS core 614, to facilitate communications between WTRUs 602 and traditional land-line communications devices. In addition, core network 606 may provide the WTRUs 602 with access to other networks 612, which may include other wired or wireless networks that are owned or operated by other service providers.

The methods and systems associated with east-west traffic monitoring as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an device for implementing content delivery as described herein. When implemented on a general-purpose processor, the program code combines with the processor to provide a unique device that operates to invoke the functionality of a streaming system.

While east-west traffic monitoring systems and methods have been described in connection with the various examples of the various figures, it is to be understood that other similar implementations may be used or modifications and additions may be made to the described examples of a system or method without deviating therefrom. For example, one skilled in the art will recognize that a streaming system as described in the instant application may apply to other environments combining both local and network elements and components. Therefore, east-west traffic monitoring systems and methods as described herein should not be limited to any single example, but rather should be construed in breadth and scope in accordance with the appended claims and other disclosed embodiments.

What is claimed is:

1. A method, comprising:
generating an east-west record based on an east-west traffic interaction at a node, wherein the east-west record includes a source, a destination, and a type; and
storing the east-west record in a record cache of a peripheral memory device associated with the node.

2. The method of claim 1, wherein the east-west record is generated by a switch communicatively coupled with the node.

3. The method of claim 1, wherein the east-west record is generated by the node.

4. The method of claim 1, further comprising:
determining that remaining record cache storage is below a threshold;
transmitting the east-west record to a record database; and
deleting the east-west record from the record cache.

5. The method of claim 4, further comprising:
calculating a pattern among a plurality of records from the record database including the east-west record.

6. The method of claim 5, further comprising:
generating a traffic model from the plurality of records using a forwarding table.

7. The method of claim 1, further comprising:
reconciling the east-west record, wherein the east-west record is indicated reconciled if a corresponding record at a second node is located, and wherein the east-west record is indicated failed if a corresponding record at a second node is not located.

8. The method of claim 7, wherein at least one of the node and the second node is a virtualized node, and wherein the east-west record further includes a hypervisor identifier.

9. The method of claim 7, wherein at least one of the node and the second node is a hardware node.

10. The method of claim 1, wherein the node is a virtualized node, and wherein the record cache is associated with a physical server supporting the virtualized node.

11. The method of claim 10, wherein the record cache stores an additional east-west record based on an additional traffic interaction to or from an additional node.

12. The method of claim 1, wherein at least one of generating the east-west record and storing the east-west record utilizes a direct memory access flow.

13. The method of claim 12, wherein the node is a virtualized node, and wherein the direct memory access flow is performed using an expansion bus of a hardware server hosting the node.

14. A system, comprising:
a record generator configured to generate an east-west record based on a traffic interaction at a node, wherein the east-west record includes a source, a destination, and a type; and
a record cache of a peripheral memory device associated with the node configured to store the east-west record.

15. The system of claim 14, further comprising:
a record database configured to receive the east-west record before the record cache is cleared.

16. The system of claim 15, further comprising:
a record learning engine configured to calculate a pattern among a plurality of records from the record database including the east-west record.

17. The system of claim 14, further comprising:
a record learning engine configured to reconcile the east-west record, wherein the east-west record is indicated reconciled if a corresponding record at a second node is located, and wherein the east-west record is indicated failed if a corresponding record at a second node is not located.

18. The system of claim 14, wherein the node is a virtualized node, wherein the record cache is associated with a physical server supporting the virtualized node, and wherein the east-west record includes a hypervisor identifier.

19. The system of claim 14, wherein the record generator utilizes a direct memory access flow.

20. A non-transitory computer readable medium storing instructions that when executed perform aspects including:
generating an east-west record based on a traffic interaction at a virtualized node, wherein the east-west record includes a source, a destination, a type, and a hypervisor identifier; and
storing the east-west record using a record cache of a peripheral memory device associated with the virtualized node.
